(19) United States
(12) Patent Application Publication
(10) Pub. No.: US 2020/0200993 A1
(43) Pub. Date: Jun. 25, 2020

(54) DEVICE AND METHOD FOR INSTALLING AND FIXING LENS

(71) Applicant: GUANGZHOU UNIONLUX ELECTRONIC TECHNOLOGY CO., LTD., Guangzhou (CN)

(72) Inventor: Shuyao YANG, Guangzhou (CN)

(21) Appl. No.: 16/805,114

(22) Filed: Feb. 28, 2020

Related U.S. Application Data
(63) Continuation of application No. PCT/CN2018/103592, filed on Aug. 31, 2018.

(30) Foreign Application Priority Data
Aug. 31, 2017 (CN) 201710767317.1

(51) Int. Cl. G02B 7/02

(52) U.S. Cl. CPC G02B 7/025; G02B 7/021; G02B 7/023

(57) ABSTRACT

The present discloses a device and method for installing and fixing lens. The device for installing and fixing lens includes a lens installation support. A plurality of through holes for placing lenses are provided in the lens installation support, and glue injection holes communicated with the through holes are provided around each through hole in the lens installation support so that when a lens is placed in the through hole, glue will be injected into the glue injection hole, the glue then will permeate around the lens and the through hole to paste the lens in the through hole, and the lens will be installed and fixed once the glue is cured. The device for installing and fixing lens is simple in structure, easy to install and fix the lens with high installation and fixation accuracy and good stability.

### CROSS REFERENCE TO RELATED APPLICATIONS

The present application is a continuation of International Application No. PCT/CN2018/103592, filed on Aug. 31, 2018, which claims priority from Chinese Patent Application No. 201710767317.1 filed on Aug. 31, 2017, all of which are hereby incorporated herein by reference.

### TECHNICAL FIELD

The invention relates to the technical field of installing and fixing lens, in particular to a device for installing and fixing lens and a method for installing and fixing lens.

### BACKGROUND

Traditional devices for installing and fixing lens include lens tube and pressing ring. The lens is fixed by the pressing ring after being placed on the lens tube. This installation and fixation method is only suitable for a single lens. However, in most cases, a light source module generally includes a plurality of closely arranged light sources, and each light source requires a lens respectively to transmit light and the lenses are required to be closely arranged with each other. At the same time, if the lens tube and the pressing ring are used to install and fix the lens, the installing and fixing process will be more complicated and difficult, as well as in low accuracy and stability.

### SUMMARY OF THE INVENTION

The invention provides a device for installing and fixing lens with simple structure, which is easy to install and fix the lens with good accuracy and stability.

According to the present invention, the device for installing and fixing lens includes a lens installation support. A plurality of through holes for placing lenses are provided in the lens installation support, and glue injection holes communicated with the through holes are provided around each through hole in the lens installation support. The glue injection holes are configured to be not penetrated the lens installation support.

According to the present invention, the through holes and the glue injection holes communicated with the through holes are provided in the lens installation support, so that when a lens is placed in a through hole, glue will be injected into the glue injection hole, the glue then will permeate around the lens and the through hole to paste the lens in the through hole, and the lens will be installed and fixed once the glue is cured. The device for installing and fixing lens according to the present invention is simple in structure, which is easy to install and fix the lens with high installation and fixation accuracy and good stability.

In one preferred embodiment, the device further comprises a lens positioning plate for fixing the lens installation support. The lens positioning plate is provided with bosses having the same arrangement with the through holes. During installation, the bosses are in one-to-one correspondence with the through holes, and the distance between the lower face of the lens installation support and the upper surface of the bosses is less than the thickness of the edge of the lens. When in use, LED chips are attached on the bosses, such arrangement can prevent the glue from flowing to the bottom of the lens to influence light transmission of the lens when the glue is injected into the glue injection hole, and simultaneously avoid part of LED light due to long distance between the lower face of the lens installation support and the upper surface of the bosses, thereby improving light efficiency. The lower surface of the lens installation support is preferably located on the same plane with the upper surface of the bosses. Such arrangement further allows the bosses to abut the lens, so that the glue can be prevented from flowing to the bottom of the lens to influence light transmission of the lens when the glue is injected into the glue injection hole, it is also convenient to adjust the curvature of the lens to achieve better focus.

Preferably, the size of the bosses is smaller than that of the through hole. Such arrangement allows the glue to continue to flow towards the bottom of the bosses along the bosses when the glue flows to the bottom of the lens, which will not cause the lens to adhere to the bosses to bring difficulties to the separation between the lens positioning plate and the lens installation support. The size of bosses is preferably less than that of the lens and the bosses are in regular polygon structure or cylindrical structure.

A positioning element is provided on the lens installation support for positioning the fixed position of the lens installation support on the lens positioning plate. This arrangement facilitates quick and accurate fixation of the lens installation support to the lens positioning plate, thus improving the speed and effect of installing and fixing the lens. If the positioning element is not provided, it is difficult to guarantee that the bosses is in one-to-one correspondence to the through hole, which will influence the installing and fixing effect of the lens.

The positioning element includes a plurality of positioning pins that are provided on opposite sides or at opposite angles of the lens installation support, and insertion holes for sleeving the positioning pins are provided on the lens positioning plate. The lens installation support can be accurately fixed on the lens positioning plate by the means of inserting the positioning pin into the insertion hole and fasten the positioning pin by a screw or a quick-lock structure.

The positioning element further includes a plurality of positioning posts that are provided on opposite sides or at opposite angles of the lens installation support, and positioning surfaces corresponding to the positioning posts are provided on the lens positioning plate. This arrangement provides a secondary positioning, which further ensures the accuracy of fixing the lens installation support on the lens positioning plate.

Preferably, two glue injection holes are symmetrically provided around each through hole. When the glue is simultaneously injected into the two glue injection holes, the glue will permeate around the lens and the through hole starting from the two glue injection holes, which guarantees rapid permeation and uniformity of permeation and further improves the speed and effect of installing and fixing the lens.

Preferably, the size of the through hole gradually increases from the bottom to the top, or the top of the through hole is in a flared structure. Such arrangement facilitates pick-and-place operation of the lens in the through hole.

Preferably, the depth of the through hole is greater than or equal to the height of the lens. Such arrangement allows the lens that is well installed and fixed to be fully in the through hole, which can prevent the lens friction caused by the lens protruding outside the through hole, thus improving light transmission.

Preferably, the size of the through hole is 0.01 mm to 0.2 mm greater than that of the lens. Such arrangement not only facilitates the pick-and-place operation of the lens in the through hole, but also facilitates the permeation of the glue around the lens and the through hole. The size of the through hole is preferably 0.01 mm to 0.05 mm greater than that of the lens.

Preferably, the diameter of the glue injection hole is smaller than the radius of the through hole.

Preferably, the through holes are arranged in an array in the lens installation support. Compared with the through holes in a disordered arrangement, such configuration is convenient for the arrangement of the through holes in the lens installation support, and facilitates the production of the device for installing and fixing lens.

The present invention further provides a method for installing and fixing lens, which uses the above device for installing and fixing lens including a lens positioning plate for fixing the lens installation support. The lens positioning plate is provided with bosses having the same arrangement with the through holes. The method includes the following installing and fixing steps.

S1. the lens installation support is fixed on the lens positioning plate when the lens positioning plate is placed on a flat surface, so that the bosses is in one-to-one correspondence with the through hole, and the lower surface of the lens installation support is located on the same plane with the upper surface of the bosses;

S2. the bosses abut the lens after the lens is placed in the through hole, and glue is injected into the glue injection hole; and

S3. the lens positioning plate and the lens installation support which are fixed together are subjected to glue curing treatment after injecting glue; and

S4, the lens positioning plate is separated from the lens installation support after the curing treatment so as to complete the installation and fixation of the lens on the lens installation support.

In the present invention, the bosses abut the lens, so that the glue can be prevented from flowing to the bottom of the lens to influence light transmission of the lens when the glue is injected into the glue injection hole. The method for installing and fixing lens provided by the invention is simple in operation, easy to install and fix the lens, and high in installation and fixation accuracy and good in stability.

Preferably, a high-temperature baking or ultraviolet irradiation method is used in step S3 to perform glue curing treatment on the lens positioning plate and the lens installation support which are fixed together. In actual use, method can be selected to perform curing treatment according to the characteristics of the glue.

Preferably, a positioning element is provided on the lens installation support for positioning the fixing position of the lens installation support on the lens positioning plate. Such arrangement facilitates quick and accurate fixation of the lens installation support to the lens positioning plate, thus improving the speed and effect of installing and fixing the lens. If the positioning element is not provided, it is difficult to guarantee that the bosses is in one-to-one correspondence with the through hole, which can influence the installing and fixing effect of the lens. Further preferably, the positioning element includes a plurality of positioning pins that are provided on opposite sides or at opposite angles of the lens installation support, and insertion holes for sleeving the positioning pins are provided on the lens positioning plate. The lens installation support can be accurately fixed on the lens positioning plate by the means of inserting the positioning pin into the insertion hole and fasten the positioning pin by a screw or a quick-lock structure. Further preferably, the positioning element further includes a plurality of positioning posts that are provided on opposite sides or at opposite angles of the lens installation support, and positioning surfaces corresponding to the positioning posts are provided on the lens positioning plate. This arrangement provides a secondary positioning, which further ensures the accuracy of fixing the lens installation support on the lens positioning plate.

Preferably, the size of the bosses is smaller than that of the through hole. Such arrangement allows the glue to continue to flow towards the bottom of the bosses along the bosses when the glue flows to the bottom of the lens, which will not cause the lens to adhere to the bosses and will not bring difficulties to the separation between the lens positioning plate and the lens installation support. Preferably, the bosses are in regular polygon structure or circular structure.

The device for installing and fixing lens according to the present invention can achieve to install and fix lens through the configuration of the through holes and the glue injection holes communicated with the through holes in the lens installation support. When the lens is placed in the through hole, glue will be injected into the glue injection hole, the glue then will permeate around the lens and the through hole to paste the lens in the through hole, and the lens then be installed and fixed after the glue is cured. The device for installing and fixing lens is thus simple in structure, easy to install and fix the lens with high installation and fixation accuracy and good stability. Besides, two glue injection holes are symmetrically provided around each through hole. When the glue is simultaneously injected into the two glue injection holes, the glue will permeate around the lens and the through hole together starting from the two glue injection holes, which guarantees rapid permeation and uniformity of permeation and further improves the speed and effect of installing and fixing the lens. Moreover, the size of the through hole is configurated to gradually increase from the bottom to the top, or the top of the through hole is in a flared structure, which facilitates the pick-and-place operation of the lens in the through hole. By means of arranging the depth of the through hole as greater than or equal to the height of the lens, the lens that is well installed and fixed can be fully placed in the through hole, which can prevent the lens friction caused by the lens protruding outside the through hole, thus influencing light transmission. The invention also provides a method for installing and fixing lens, in which the bosses abuts the lens, so that the glue can be prevented from flowing to the bottom of the lens to influence the use of the lens when the glue is injected into the glue injection hole. The method is simple in operation, easy to install and fix the lens with high installation and fixation accuracy and good stability.

### BRIEF DESCRIPTION OF THE DRAWINGS

FIG. 1 is a schematic view of a device for installing and fixing lens according to an embodiment.

FIG. 2 is a schematic view of the device for installing and fixing lens from another angle according to the embodiment, in which the lens is placed over a through hole.

FIG. 3 is a cross-sectional view of lenses being installed on through holes.

FIG. 4 is an installing and matching diagram of a lens installation support and a lens positioning plate.

### DETAILED DESCRIPTION OF EMBODIMENTS

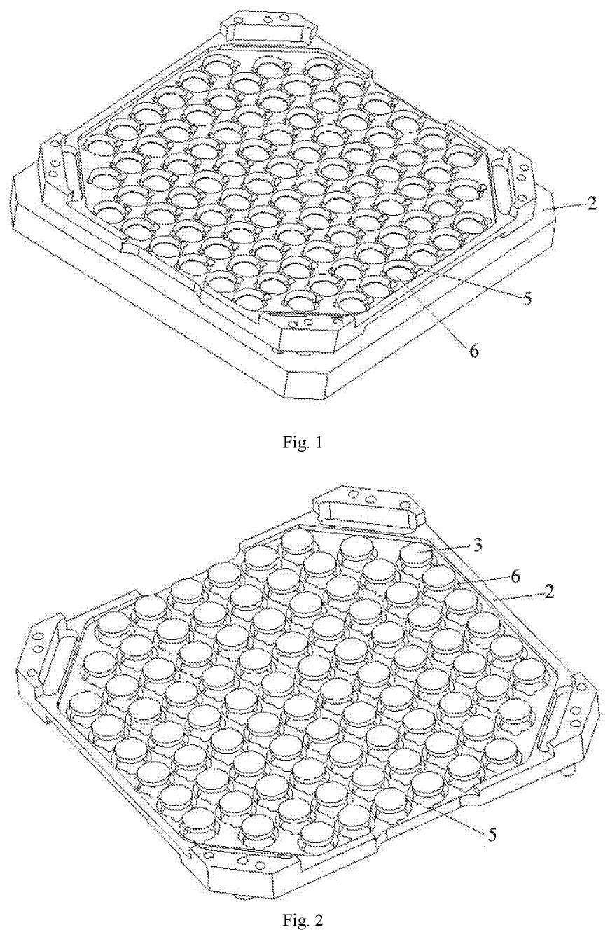

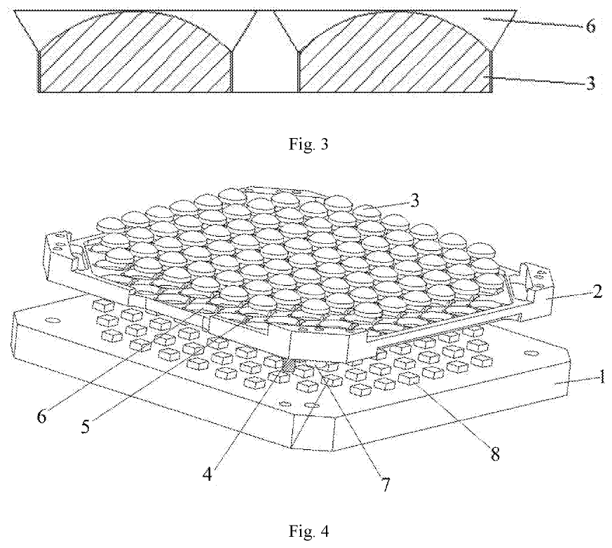

The present embodiment provides a device for installing and fixing lens. As shown in FIGS. 1 to 3, the device includes a lens installation support 2. A plurality of through holes 6 for placing lenses 3 are provided in the lens installation support 2, and glue injection holes 5 communicated with the through holes 6 are provided around each through hole 6 in the lens installation support 2. The glue injection holes 5 are not penetrated the lens installation support 2.

According to the embodiment, the through holes 6 and the glue injection holes 5 communicated with the through holes 6 are provided in the lens installation support 2, so that when the lens 3 is placed in the through hole 6, glue will be injected into the glue injection hole 5, the glue then will permeate around the lens 3 and the through hole 6 to paste the lens 3 in the through hole 6, and the lens 3 will be installed and fixed once the glue is cured. The device for installing and fixing lens is simple in structure, which is easy to install and fix the lens with high installation and fixation accuracy and good stability.

Two glue injection holes 5 are symmetrically provided around each through hole 6. When the glue is simultaneously injected into the two glue injection holes 5, the glue will permeate around the lens 3 and the through hole 6 together starting from the two glue injection holes 5, which guarantees rapid permeation and uniformity of permeation and improves the speed and effect of installing and fixing the lens.

In addition, the size of the through hole 6 gradually increases from the bottom to the top, or the top of the through hole 6 is in a flared structure. This arrangement facilitates pick-and-place operation of the lens in the through hole. In the present embodiment, the top of the through hole 6 is provided to be in a flare structure.

The depth of the through hole 6 is greater than or equal to the height of the lens. This arrangement allows the lens that is well installed and fixed to be fully in the through hole in order to prevent the lens friction which is caused by the lens protruding outside the through hole and influences light transmission. In the present embodiment, the depth of the through hole 6 is equal to the height of the lens 3.

In addition, the size of the through hole 6 is 0.01 mm to 0.05 mm greater than that of the lens. This arrangement not only facilitates the pick-and-place operation of the lens 3 on the through hole 6, but also facilitates the permeation of the glue around the lens 3 and the through hole 6.

The diameter of the glue injection hole 5 is smaller than the radius of the through hole 6.

In addition, the through holes 6 are arranged in an array in the lens installation support 2. Compared with the through holes 6 in a disordered arrangement, the present configuration is convenient for the arrangement of the through holes 6 to be provided in the lens installation support 2, and facilitates the production of the device for installing and fixing lens.

The embodiment further provides a method for installing and fixing lens, which uses the above device for installing and fixing lens and a lens positioning plate 1 for fixing the lens installation support 2. As shown in FIG. 4, the lens positioning plate 1 is provided with bosses 8 having the same arrangement with the through holes 6. The method includes the following installing and fixing steps.

S1. the lens installation support 2 is fixed on the lens positioning plate 1 when the lens positioning plate 1 is placed on a flat surface, so that the bosses 8 are in one-to-one correspondence with the through holes 6, and the lower surface of the lens installation support 2 is located on the same plane with the upper surface of the bosses 8;

S2. the bosses 8 abuts the lens 3 after the lens 3 is placed in the through hole 6, and glue is injected into the glue injection hole 5;

S3. the lens positioning plate 1 and the lens installation support 2 which are fixed together are subjected to glue curing treatment after injecting glue; and

S4. the lens positioning plate 1 is separated from the lens installation support 2 after the curing treatment so as to complete the installation and fixation of the lens 3 on the lens installation support 2.

In the present embodiment, the bosses 8 abut the lens 3, so that the glue can be prevented from flowing to the bottom of the lens 3 to influence light transmission of the lens 3 when the glue is injected into the glue injection hole 5. The method for installing and fixing lens provided by the invention is simple in operation, easy to install and fix the lens, and high in installation and fixation accuracy and good in stability.

In step S3, a high-temperature baking or ultraviolet irradiation method is used to perform glue curing treatment on the lens positioning plate 1 and the lens installation support 2 which are fixed together. In actual use, method can be selected to perform curing treatment according to the characteristics of the glue.

In addition, a positioning element is provided on the lens installation support 2 for positioning the fixing position of the lens installation support 2 on the lens positioning plate 1. This arrangement facilitates quick and accurate fixation of the lens installation support 2 to the lens positioning plate 1, thus improving the speed and effect of installing and fixing the lens 3. If the positioning element is not provided, it is difficult to guarantee that the bosses is in one-to-one correspondence, which will influence the installing and fixing effect of the lens 3.

The positioning element includes a plurality of positioning pins 4 that are provided on opposite sides or at opposite angles of the lens installation support 2, and insertion holes for sleeving the positioning pins 4 are provided on the lens positioning plate 1. The lens installation support 2 can be accurately fixed on the lens positioning plate 1 by the means of inserting the positioning pin into the insertion hole and fasten the positioning pin by a screw or a quick-lock structure.

In the present embodiment, the positioning element further includes a plurality of positioning posts 7 that are provided on opposite sides or at opposite angles of the lens installation support 2, and positioning surfaces corresponding to the positioning posts 7 are provided on the lens positioning plate 1. This arrangement provides a secondary positioning, which further ensures the accuracy of fixing the lens installation support 2 on the lens positioning plate 1.

The size of the bosses 8 is smaller than that of the through hole 6. This arrangement allows the glue to continue to flow towards the bottom of the bosses 8 along the bosses 8 when the glue flows to the bottom of the lens 3, which will not cause the lens 3 to adhere to the bosses 8 to bring difficulties to the separation between the lens positioning plate 1 and the lens installation support 2. In the present embodiment, the bosses 8 is in a regular polygon structure or a circular structure.

1. A device for installing and fixing lens, comprising a lens installation support, wherein a plurality of through holes for placing lenses are provided in the lens installation support, and glue injection holes communicated with the plurality of through holes are provided around each of the plurality of through holes in the lens installation support.

2. The device for installing and fixing lens according to claim 1, further comprising a lens positioning plate for fixing the lens installation support, wherein the lens positioning plate is provided with bosses having the same arrangement with the plurality of through holes; when installing, the bosses are configurated to be in in one-to-one correspondence with the plurality of through holes.

3. The device for installing and fixing lens according to claim 2, wherein when the the lens installation support is fixed on the lens positioning plate, a distance between a lower face of the lens installation support and an upper surface of the bosses is less than a thickness of the edge of a lens.

4. The device for installing and fixing lens according to claim 2, wherein when the the lens installation support is fixed on the lens positioning plate, a lower surface of the lens installation support is configurated to be located on the same plane with an upper surface of the bosses.

5. The device for installing and fixing lens according to claim 2, wherein a size of the bosses is smaller than that of the plurality of through holes.

6. The device for installing and fixing lens according to claim 2, wherein a size of the bosses is smaller than that of the lens.

7. The device for installing and fixing lens according to claim 1, wherein a positioning element is provided on the lens installation support for positioning the fixing position of the lens installation support on the lens positioning plate.

8. The device for installing and fixing lens according to claim 7, wherein the positioning element includes a plurality of positioning pins provided on opposite sides or at opposite angles of the lens installation support, and insertion holes for sleeving the plurality of positioning pins are provided on the lens positioning plate.

9. The device for installing and fixing lens according to claim 8, wherein the positioning element further includes a plurality of positioning posts that are provided on opposite sides or at opposite angles of the lens installation support, and positioning surfaces corresponding to the plurality of positioning posts are provided on the lens positioning plate.

10. The device for installing and fixing lens according to claim 1, wherein two glue injection holes are symmetrically provided around each of the plurality of through holes.

11. The device for installing and fixing lens according to claim 1, wherein a size of the plurality of through holes gradually increases from the bottom to the top, or a top of the plurality of through holes is in a flared structure.

12. The device for installing and fixing lens according to claim 1, wherein a depth of the plurality of through holes is greater than or equal to a height of the lens.

13. The device for installing and fixing lens according to claim 1, wherein a size of the plurality of through holes is 0.01 mm to 0.2 mm greater than that of the lens.

14. The device for installing and fixing lens according to claim 1, wherein a diameter of the glue injection holes is smaller than a radius of the plurality of through holes.

15. The device for installing and fixing lens according to claim 1, wherein the plurality of through holes are arranged in an array on the lens installation support.

16. A method for installing and fixing lens, using a device for installing and fixing lens according to claim 1 and a lens positioning plate for fixing a lens installation support in which the lens positioning plate is provided with bosses having the same arrangement with through holes, comprising the following installing and fixing steps:
S1. the lens installation support is fixed on the lens positioning plate when the lens positioning plate is placed on a flat surface, so that the bosses are in one-to-one correspondence with the through hole, and the lower surface of the lens installation support is located on the same plane with the upper surface of the bosses;
S2. the bosses abut the lens after the lenses are placed in the plurality of through holes, and glue is injected into the glue injection holes;
S3, the lens positioning plate and the lens installation support which are fixed together are subjected to glue curing treatment after injecting glue; and
S4, the lens positioning plate is separated from the lens installation support after the curing treatment so as to complete the installation and fixation of the lens on the lens installation support.

17. The method for installing and fixing lens according to claim 16, wherein a high-temperature baking or ultraviolet irradiation method is used in step S3 to perform glue curing treatment on the lens positioning plate and the lens installation support which are fixed together.

18. The method for installing and fixing lens according to claim 16, wherein a positioning element is provided on the lens installation support for positioning the fixing position of the lens installation support on the lens positioning plate.

19. The method for installing and fixing lens according to claim 18, wherein the positioning element includes a plurality of positioning pins that are provided on opposite sides or at opposite angles of the lens installation support, and insertion holes for sleeving the positioning pins are provided on the lens positioning plate.

20. The method for installing and fixing lens according to claim 19, wherein the positioning element further includes a plurality of positioning posts that are provided on opposite sides or at opposite angles of the lens installation support, and positioning surfaces corresponding to the positioning posts are provided on the lens positioning plate.
